(19) United States
(12) Patent Application Publication
(10) Pub. No.: US 2015/0111649 A1
(43) Pub. Date: Apr. 23, 2015

(54) FRAMEWORK TO ENABLE CONSUMPTION OF CAPTURED GAMEPLAY DATA OVER MULTIPLE MEDIUMS CONCURRENTLY

(71) Applicant: Nvidia Corporation, Santa Clara, CA (US)

(72) Inventors: Lu Liu, Santa Clara, CA (US); Rochelle Pereira, Santa Clara, CA (US); Somnath Kopnar, Pune (IN)

(21) Appl. No.: 14/521,882

(22) Filed: Oct. 23, 2014

Related U.S. Application Data
(60) Provisional application No. 61/894,747, filed on Oct. 23, 2013.

(51) Int. Cl. A63F 13/49

(52) U.S. Cl. CPC A63F 13/49
USPC 463/43

(57) ABSTRACT

A game recording unit includes a gaming data capture section coupled to a game playing unit and configured to capture gameplay audio and video data for processing as directed by a game user control input. The game recording unit also includes a gaming data processing section coupled to the gaming data capture section and configured to process the gameplay audio and video data, wherein the processing includes a manual mode, a gamecast mode and a shadow mode of gameplay capture. Additionally, game recording unit includes a gaming data output section coupled to the gaming data processing section and configured to provide output options for the manual, gamecast and shadow modes. A game recording method and a game recording system are also included.

### CROSS-REFERENCE TO RELATED APPLICATION

This application claims the benefit of U.S. Provisional Application Ser. No. 61/894,747, filed by Lu Liu, et. al, on Oct. 23, 2013, entitled “Framework To Enable Consumption of Captured Gameplay Data Over Multiple Mediums Simultaneously,” commonly assigned with this application and incorporated herein by reference.

### TECHNICAL FIELD

This application is directed, in general, to video gaming and, more specifically, to a game recording unit, a game recording method and a game recording system.

### BACKGROUND

Enthusiastic video game players may want to enhance their game playing by capturing portions of their gameplay for additional use. This is especially true where scoring or advancement is achieved when performing special gaming actions that may include tricks or stunts. Current gameplay capture capabilities are somewhat limited in overall scope and often accommodate only a single capture mode. Additionally, current gameplay capture may interfere more than desired with gameplay itself. It would be beneficial to the art if multiple and concurrent gameplay actions could be captured and preserved without significantly disturbing gameplay.

### SUMMARY

Embodiments of the present disclosure provide a game recording unit, a game recording method and a game recording system.

In one embodiment, the game recording unit includes a gaming data capture section coupled to a game playing unit and configured to capture gameplay audio and video data for processing as directed by a game user control input. The game recording unit also includes a gaming data processing section coupled to the gaming data capture section and configured to process the gameplay audio and video data, wherein the processing includes a manual mode, a gamecast mode and a shadow mode of gameplay capture. Additionally, game recording unit includes a gaming data output section coupled to the gaming data processing section and configured to provide output options for the manual, gamecast and shadow modes.

In another aspect, the game recording method includes capturing gameplay audio and video data from a game playing unit for processing as directed by a game user control input, processing the gameplay audio and video data for a manual mode, a gamecast mode and a shadow mode of gameplay capture and providing output options for the manual, gamecast and shadow modes.

In yet another aspect, the game recording system includes a game playing unit that provides a gaming environment for a game user and a game recording unit having a gaming data capture section that is coupled to the game playing unit and captures gameplay audio and video data for processing as directed by a control input from the game user. Also, the game recording unit has a gaming data processing section that is coupled to the gaming data capture section and processes the gameplay audio and video data for a manual mode, a gamecast mode and a shadow mode of gameplay capture. Additionally, the game recording unit has a gaming data output section that is coupled to the gaming data processing section and provides output options for the manual, gamecast and shadow modes.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

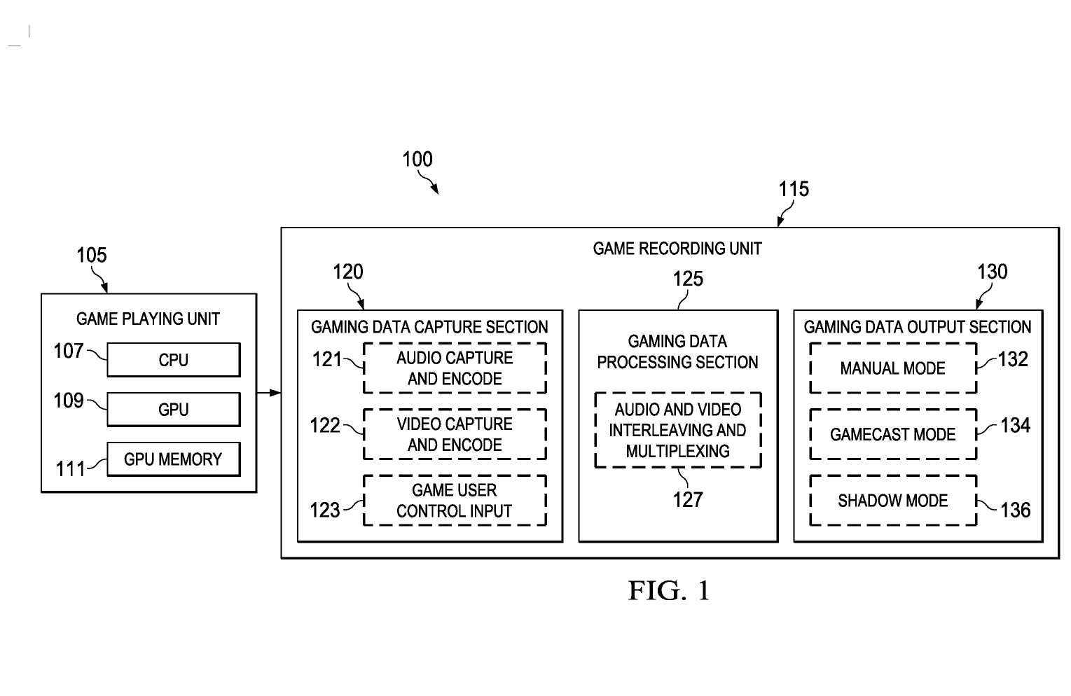

FIG. 1 illustrates a diagram of an embodiment of a game recording system constructed according to the principles of the present disclosure;

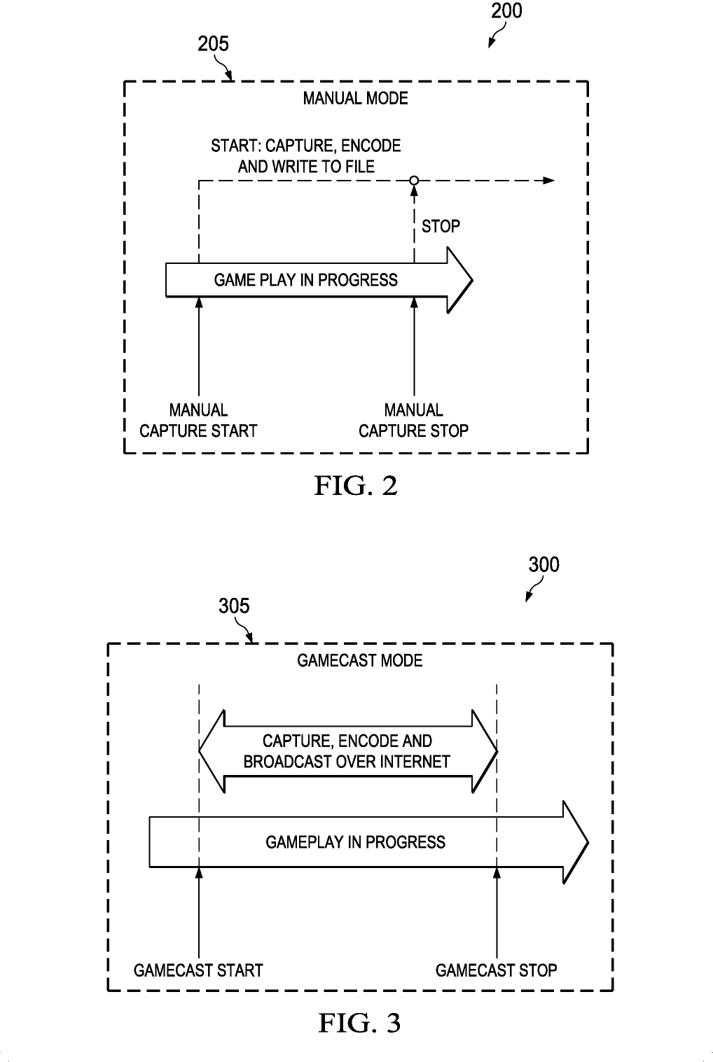

FIG. 2 illustrates a diagram of an embodiment of a manual mode of gameplay capture and recording constructed according to the principles of the present disclosure;

FIG. 3 illustrates a diagram of an embodiment of a gamecast mode of gameplay capture and recording constructed according to the principles of the present disclosure;

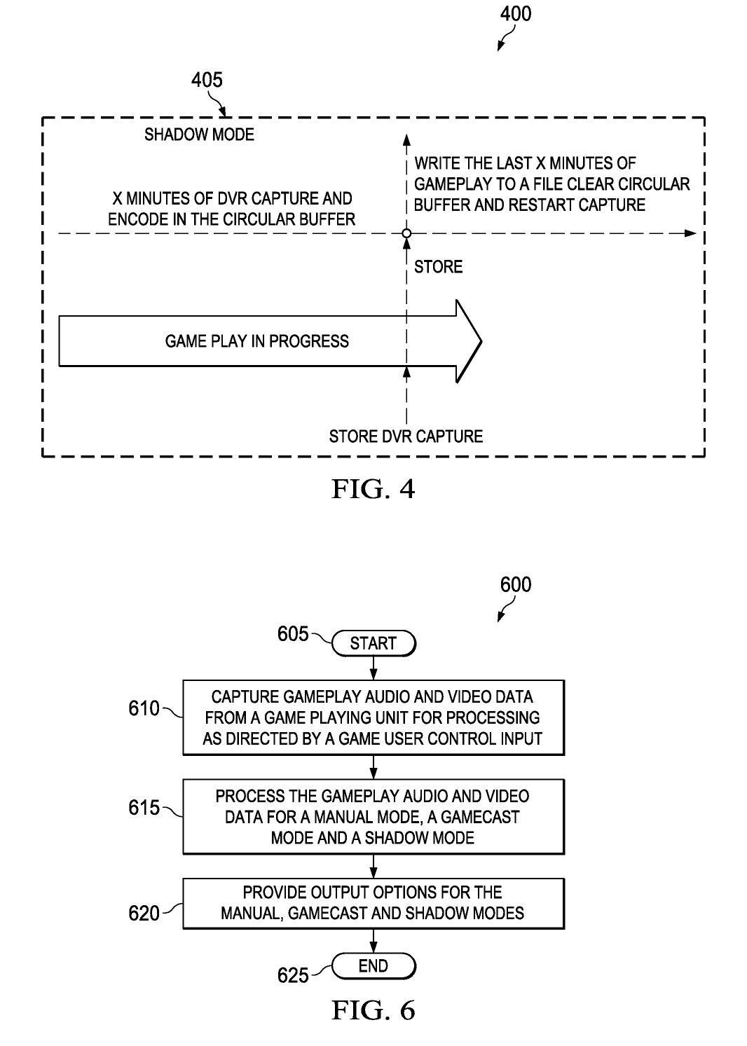

FIG. 4 illustrates a diagram of an embodiment of a shadow mode of gameplay capture and recording constructed according to the principles of the present disclosure;

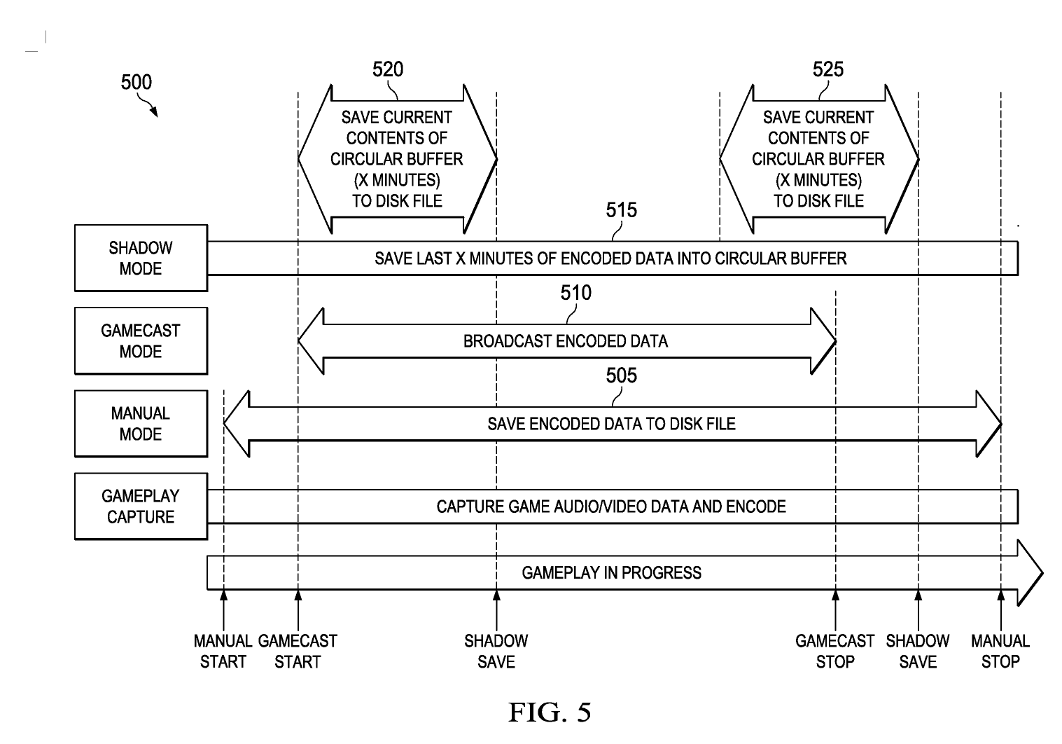

FIG. 5 illustrates a diagram of an embodiment of concurrent modes of gameplay capture and recording constructed according to the principles of the present disclosure; and

FIG. 6 illustrates a flowchart of an embodiment of a game recording method carried out according to the principles of the present disclosure.

### DETAILED DESCRIPTION

Embodiments of the present disclosure provide a framework that enables gameplay capturing and recording from a game playing unit. The gameplay capturing and recording is accomplished in the background while having minimal impact on playing the game. The gameplay capture may be employed in real time using a single capture mode or using two or more concurrent capture modes. These include a manual capture mode, a gamecast capture mode and a shadow capture mode that generally accommodate output options employing saving gameplay to a memory device, broadcasting gameplay over a network and buffering at least a portion of gameplay for possible recording.

FIG. 1 illustrates a diagram of an embodiment of a game recording system, generally designated 100, constructed according to the principles of the present disclosure. The game recording system 100 includes a game playing unit 105 and a game recording unit 115. The game recording unit 115 includes a gaming data capture section 120, a gaming data processing section 125 and a gaming data output section 130.

The game playing unit 105 provides a gaming environment for a game user and includes a central processing unit (CPU) 107, a graphics processing unit (GPU) 109 and a GPU memory 111. The CPU 107 provides general processing for the game recording unit 105. Similarly, the GPU 109 employs the GPU memory 111 to provide graphics processing for the game recording unit 105.

The gaming data capture section 120 includes an audio capture and encode portion 121, a video capture and encode portion 122 and a game user control input portion 123. In the illustrated embodiment, the gaming data capture section 120 is coupled to the game playing unit 105 and captures gameplay audio and video data for processing as directed by a control input from the game user. Here, the gameplay audio addressed by the audio capture and encode portion 121 typically corresponds to gameplay video frame data of the game playing unit 105.

The video capture and encode portion 122 is coupled to the GPU memory 111 to directly receive gameplay video frame data from the game playing unit 105. This direct coupling enables essentially transparent playing of a video game during game recording. A game user control input may generally be selected by employing a key stroke (e.g., from a key pad or a keyboard), by providing a pointing device action (e.g., from a computer mouse click) or by making a touch screen selection (e.g., from a menu touch screen).

The gaming data processing section 125 is coupled to the gaming data capture section 120 and processes the gameplay audio and video data. In the illustrated embodiment, an audio and video interleaving and multiplexing portion 127 provides processing of the gameplay audio and video data for a manual mode, a gamecast mode and a shadow mode of gameplay capture. As determined by the game user control input portion 123, each of the manual, gamecast and shadow modes may be activated separately. Alternately, two or more of the manual, gamecast and shadow modes may be activated concurrently.

The gaming data output section 130 is coupled to the gaming data processing section 125 and provides manual mode output options 132, gamecast mode output options 134 and shadow mode output options 136. Generally, the output options for the manual, gamecast and shadow modes may be selected from the group consisting of encoded data saved to a memory device, encoded data broadcast over a network and encoded data provided to a circular buffer. In one example, a manual mode output option may be encoded data saved to a memory device such as a disk or flash drive. Also, a gamecast mode output option may be encoded data broadcast over the Internet or another public or private network. Additionally, a shadow mode output option may be encoded data provided to a circular buffer that may be later saved to a memory device.

FIG. 2 illustrates a diagram of an embodiment of a manual mode of gameplay capture and recording, generally designated 200, constructed according to the principles of the present disclosure. The manual mode 200 is representative of a separately (i.e., singularly) activated manual mode wherein a recording is obtained in real time. Here, a game user controls when to start and stop the manual capture and recording, wherein recorded audio and video data are interleaved, multiplexed and saved to a memory device, in real time. The manual mode 200 shows that gameplay is in process when a capture start is initiated. Then, at a following point in the gameplay, the capture is stopped, and captured and encoded audio and video data are saved to a memory device. This recording session may be one of multiple back to back recording sessions.

FIG. 3 illustrates a diagram of an embodiment of a gamecast mode of gameplay capture and recording, generally designated 300, constructed according to the principles of the present disclosure. The gamecast mode 300 is representative of a separately activated gamecast mode wherein a live broadcast is conducted in real time. In this mode, recorded gameplay data is directly broadcasted live over a user-configured network connection (e.g., employing the Internet). A game user may control when to start and stop the broadcast using a hotkey, a pointing device or a touch screen selection, for example.

FIG. 4 illustrates a diagram of an embodiment of a shadow mode of gameplay capture and recording, generally designated 400, constructed according to the principles of the present disclosure. The shadow mode 400 is representative of a separately activated shadow mode wherein a recording is buffered (e.g., a circular buffer may be employed) in real time to capture a designated quantity of gameplay data. In this mode and while gameplay is in progress, data buffering of a selected amount of gameplay history is maintained. At a time indicated by a game user control input, the selected amount of gameplay history may be saved to a memory device. A new shadow mode session may be started at the same time without incurring loss of video frames. Multiple back to back recording sessions may also be accommodated.

FIG. 5 illustrates a diagram of an embodiment of concurrent modes of gameplay capture and recording, generally designated 500, constructed according to the principles of the present disclosure. The concurrent gameplay capture and recording modes 500 show that gameplay and gameplay capture are in progress and additionally include gaming capture corresponding to a manual mode 505, a gamecast mode 510 and a shadow mode 515 with two examples of circular buffer recording 520, 525, as shown. Some portion of each of the concurrent gameplay capture modes shown is initiated and further controlled by game user control inputs, as generally discussed previously.

In the illustrated example of FIG. 5, the manual mode 505 is controlled by manual mode start and stop commands, and encoded data are saved in to a disk file, as shown. Additionally, the gamecast mode 510 is controlled by gamecast mode start and stop commands, and encoded data are broadcast over a network, as shown. Also, the shadow mode 515 is ongoing (i.e., initiated sometime in the past and continuing into the future), wherein the two examples of circular buffer recording 520, 525 are controlled by shadow save commands, as also shown. The circular buffer recording 520, 525 are saved to disk files, in this example.

FIG. 6 illustrates a flowchart of an embodiment of a game recording method, generally designated 600, carried out according to the principles of the present disclosure. The method 600 starts in a step 605 and gameplay audio and video data are captured from a game playing unit for processing as directed by a game user control input, in a step 610. Then the gameplay audio and video data are processed for a manual mode, a gamecast mode and a shadow mode of gameplay capture, in a step 615. Output options are provided for the manual, gamecast and shadow modes, in a step 620.

In one embodiment, the gameplay audio and video data includes frame data captured from a GPU memory of the game playing unit. In another embodiment, the game user control input is selected from the group consisting of a key stroke, a pointing device action and a touch screen selection. In yet another embodiment, each of the manual, gamecast and shadow modes is activated separately. In still another embodiment, two or more of the manual, gamecast and shadow modes are activated concurrently.

In a further embodiment, processing of the gameplay audio and video data includes data interleaving and data multiplexing. In a yet further embodiment, the output options for the manual, gamecast and shadow modes are selected from the group consisting of saving encoded data to a memory device, broadcasting encoded data over a network and providing encoded data to a circular buffer. The method 600 ends in a step 625.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A game recording unit, comprising:
a gaming data capture section coupled to a game playing unit and configured to capture gameplay audio and video data for processing as directed by a game user control input;
a gaming data processing section coupled to the gaming data capture section and configured to process the gameplay audio and video data, wherein the processing includes a manual mode, a gamecast mode and a shadow mode of gameplay capture; and
a gaming data output section coupled to the gaming data processing section and configured to provide output options for the manual, gamecast and shadow modes.

2. The unit as recited in claim 1 wherein the gameplay audio and video data includes frame data captured from a GPU memory of the game playing unit.

3. The unit as recited in claim 1 wherein the game user control input is selected from the group consisting of:
a key stroke;
a pointing device action; and
a touch screen selection.

4. The unit as recited in claim 1 wherein each of the manual, gamecast and shadow modes is activated separately.

5. The unit as recited in claim 1 wherein two or more of the manual, gamecast and shadow modes are activated concurrently.

6. The unit as recited in claim 1 wherein processing of the gameplay audio and video data includes data interleaving and data multiplexing.

7. The unit as recited in claim 1 wherein the output options for the manual, gamecast and shadow modes are selected from the group consisting of:
encoded data saved to a memory device;
encoded data broadcast over a network; and
encoded data provided to a circular buffer.

8. A game recording method, comprising:
capturing gameplay audio and video data from a game playing unit for processing as directed by a game user control input;
processing the gameplay audio and video data for a manual mode, a gamecast mode and a shadow mode of gameplay capture; and
providing output options for the manual, gamecast and shadow modes.

9. The method as recited in claim 8 wherein the gameplay audio and video data includes frame data captured from a GPU memory of the game playing unit.

10. The method as recited in claim 8 wherein the game user control input is selected from the group consisting of:
a key stroke;
a pointing device action; and
a touch screen selection.

11. The method as recited in claim 8 wherein each of the manual, gamecast and shadow modes is activated separately.

12. The method as recited in claim 8 wherein two or more of the manual, gamecast and shadow modes are activated concurrently.

13. The method as recited in claim 8 wherein processing of the gameplay audio and video data includes data interleaving and data multiplexing.

14. The method as recited in claim 8 wherein the output options for the manual, gamecast and shadow modes are selected from the group consisting of:
saving encoded data to a memory device;
broadcasting encoded data over a network; and
providing encoded data to a circular buffer.

15. A game recording system, comprising:
a game playing unit that provides a gaming environment for a game user; and
a game recording unit, including:
a gaming data capture section that is coupled to the game playing unit and captures gameplay audio and video data for processing as directed by a control input from the game user,
a gaming data processing section that is coupled to the gaming data capture section and processes the gameplay audio and video data for a manual mode, a gamecast mode and a shadow mode of gameplay capture, and
a gaming data output section that is coupled to the gaming data processing section and provides output options for the manual, gamecast and shadow modes.

16. The system as recited in claim 15 wherein the gameplay audio and video data includes frame data captured from a GPU memory of the game playing unit.

17. The system as recited in claim 15 wherein the control input from the game user is selected from the group consisting of:
a key stroke;
a pointing device action; and
a touch screen selection.

18. The system as recited in claim 15 wherein operation of the manual, gamecast and shadow modes is selected from the group consisting of:
each mode is activated separately; and
two or more modes are activated concurrently.

19. The system as recited in claim 15 wherein processing of the gameplay audio and video data includes data interleaving and data multiplexing.

20. The system as recited in claim 15 wherein the output options for the manual, gamecast and shadow modes are selected from the group consisting of:
encoded data saved to a memory device;
encoded data broadcast over a network; and
encoded data provided to a circular buffer.
